(19) United States
(12) Patent Application Publication
(10) Pub. No.: US 2026/0226590 A1
(43) Pub. Date: Aug. 6, 2026

(54) AUSTENITIC STAINLESS CAST STEEL WITH WEAR RESISTANCE

(71) Applicant: IHI Corporation, Tokyo (JP)

(72) Inventors: Masahito OMIYA, Tokyo (JP); Yohei SAKAKIBARA, Tokyo (JP); Tomomichi OZAKI, Tokyo (JP); Tomomi KOKETSU, Tokyo (JP); Takahiro YAMAZAKI, Tokyo (JP)

(21) Appl. No.: 19/635,787

(22) Filed: Apr. 1, 2026

Related U.S. Application Data
(63) Continuation of application No. PCT/JP2024/044834, filed on Dec. 18, 2024.

(30) Foreign Application Priority Data
Jan. 30, 2024 (JP) 2024-011978

(51) Int. Cl. C22C 30/02; G01N 17/00

(52) U.S. Cl. CPC C22C 30/02; G01N 17/006; C22C 2202/02

(57) ABSTRACT

Austenitic stainless cast steel includes 21 to 28% by weight of Chromium, 14 to 23% by weight of Nickel, 2.0 to 3.5% by weight of Tungsten, 1.0 to 3.0% by weight of Niobium, 1.5 to 3.5% by weight of Molybdenum, 0 to 3.5% by weight of Copper, 0.6 to 1.1% by weight of Carbon, 0.1 to 0.7% by weight of Nitrogen, 1.0 to 2.0% by weight of Manganese, 0.4 to 0.7% by weight of Sulfur, 2.5 to 4.0% by weight of Silicon, and Iron as the balance.

### CROSS-REFERENCE TO RELATED APPLICATIONS

This application is a continuation application of PCT Application No. PCT/JP2024/044834, filed on Dec. 18, 2024, which claims the benefit of priority from Japanese Patent Application No. 2024-011978, filed on Jan. 30, 2024. The entire contents of the above listed PCT and priority applications are incorporated herein by reference.

### BACKGROUND

The present disclosure relates to austenitic stainless cast steel, and a method of determining a composition of austenitic stainless cast steel.

Austenitic stainless cast steel is used as a material for various machine parts. Reference documents 1 to 12 listed below disclose technologies related to austenitic heat-resistant cast steel. Austenitic stainless cast steel may be sometimes used as a material for parts constituting a vehicle turbocharger. Austenitic stainless cast steel may be used as a material for a bearing of a wastegate valve.
Reference document 1: German Patent Application Publication No. 102012203569 Specification
Reference document 2: Japanese Translation of PCT International Application Publication No. 2015-514865
Reference document 3: German Patent Application Publication No. 102006029121 Specification
Reference document 4: Japanese Patent No. 5165679
Reference Document 5: International Publication No. 2005/103314
Reference document 6: Japanese Patent No. 4985941
Reference document 7: Chinese Patent Application Publication No. 111004981 Specification
Reference document 8: Chinese Patent Application Publication No. 116057187 Specification
Reference document 9: Japanese Unexamined Patent Application Publication No. 2022-85613
Reference document 10: Chinese Patent Application Publication No. 113862562 Specification
Reference document 11: Chinese Patent Application Publication No. 114008230 Specification
Reference document 12: Japanese Patent No. 7,269,590

A wastegate valve incorporated in a turbocharger may perform an opening and closing operation. This opening and closing operation involves a phenomenon in which parts of the wastegate valve rub against each other. Therefore, for materials used for such parts rubbing against each other, resistance to wear attracts attention. For example, Reference documents 1 and 2 disclose technologies related to an austenitic iron matrix alloy focusing on wear resistance. According to the technologies disclosed in Reference documents 1 and 2, manganese sulfide (MnS) is crystallized in a solidification process during casting. As a result, a friction coefficient is reduced.

### SUMMARY

An example of austenitic stainless cast steel may include: 21 to 28% by weight of Cr; 14 to 23% by weight of Ni; 2.0 to 3.5% by weight of W; 1.0 to 3.0% by weight of Nb; 1.5 to 3.5% by weight of Mo; 0 to 3.5% by weight of Cu; 0.6 to 1.1% by weight of C; 0.1 to 0.7% by weight of N; 1.0 to 2.0% by weight of Mn; 0.4 to 0.7% by weight of S; 2.5 to 4.0% by weight of Si; and Fe as the balance.

### BRIEF DESCRIPTION OF THE DRAWINGS

FIG. 1 is an example diagram showing a concept of a method for predicting a wear amount.

FIG. 2 is an example flowchart showing some example steps of the method of determining a composition of austenitic stainless cast steel.

FIG. 3A is a contour diagram of a predicted value of a sliding wear amount using a prediction formula of the sliding wear amount when an amount of Mn is 1.0% by weight.

FIG. 3B is a contour diagram of a predicted value of a sliding wear amount using a prediction formula of the sliding wear amount when the amount of Mn is 2.0% by weight.

FIG. 4 is a table showing compositions of respective test pieces of Examples, Reference Examples, and a Comparative Example.

FIG. 5 is an example graph showing a relationship between an amount of S and an amount of crystallized MnS.

FIG. 6A is a graph showing a relationship between an amount of Si and an area ratio of MnS.

FIG. 6B is a graph showing a relationship between the amount of Si and an area ratio of eutectic carbides.

FIG. 7A is a diagram showing an outline of a test apparatus used for a high-temperature wear test.

FIG. 7B is an enlarged view of the vicinity of a test piece in FIG. 7A.

FIG. 8A is a graph showing a relationship between an amount of crystallized MnS and a wear amount at 300° C.

FIG. 8B is a graph showing a relationship between the amount of crystallized MnS and a wear amount at 900° C.

FIG. 9 is a graph showing a relationship between an amount of crystallized eutectic carbides and a wear amount at 300° C. or 900° C.

FIG. 10A is a graph showing a relationship between an amount of Si and a wear amount of a flat plate test piece at 300° C. or 900° C.

FIG. 10B is a graph showing a relationship between an amount of Si and a wear amount of a cylindrical test piece at 300° C. or 900° C.

FIG. 11 is a graph showing a relationship between an amount of Si and a total value of wear amounts of a flat plate test piece and a cylindrical test piece at 300° C. or 900° C.

FIG. 12 is a graph showing a relationship between an amount of crystallized MnS and corrosion resistance.

FIG. 13 is a graph showing a relationship between an amount of Si and Vickers hardness.

### DETAILED DESCRIPTION

In the following description, with reference to the drawings, the same reference numbers are assigned to the same components or to similar components having the same function, and overlapping description is omitted.

### Austenitic Stainless Cast Steel

A composition of the austenitic stainless cast steel will be described in detail below. In the following description, the austenitic stainless cast steel may be simply referred to as “stainless cast steel”. An amount (%) of each element is based on weight unless otherwise specified. The stainless cast steel includes 21 to 28% by weight of Cr, 14 to 23% by weight of Ni, 2.0 to 3.5% by weight of W, 1.0 to 3.0% by weight of Nb, 1.5 to 3.5% by weight of Mo, 0 to 3.5% by weight of Cu, 0.6 to 1.1% by weight of C, 0.1 to 0.7% by weight of N, 1.0 to 2.0% by weight of Mn, 0.4 to 0.7% by weight of S, and 2.5 to 4.0% by weight of Si, and includes Fe as the balance.

### Cr: Chromium

Cr is a main element included in the stainless cast steel. The amount of Cr included in the stainless cast steel is second to a content of Fe included in the stainless cast steel. Cr affects corrosion resistance, oxidation resistance, workability, and the like of the stainless cast steel. The amount of Cr in the stainless cast steel may be more than 21% by weight and 28% by weight or less. A range of the amount of Cr added to the stainless cast steel may have a portion larger than a range of an amount of Cr added to stainless cast steel specified in Japanese Industrial Standards (JIS G 5121). The amount of Cr added to the stainless cast steel may be more than 27% by weight and 28% by weight or less.

### Ni: Nickel

Ni is a main element included in the stainless cast steel. Ni affects stability of an austenite structure and castability of the cast steel. The amount of Ni in the stainless cast steel may be more than 14% by weight and 23% by weight or less. A range of the amount of Ni added to the stainless cast steel may have a portion larger than a range of an amount of Ni added to stainless cast steel specified in Japanese Industrial Standards (JIS G 5121). The amount of Ni added to the stainless cast steel may be more than 22% by weight and 23% by weight or less.

### W: Tungsten, Mo: Molybdenum

Both W and Mo affect strength of the stainless cast steel in a high-temperature environment. Both W and Mo may deteriorate the oxidation resistance of the stainless cast steel. The amount of W in the stainless cast steel may be more than 2.0% by weight and 3.5% by weight or less. The amount of Mo in the stainless cast steel may be more than 1.5% by weight and 3.5% by weight or less. A range of the amount of Mo added to the stainless cast steel may have a portion larger than a range of an amount of Mo added to stainless cast steel specified in Japanese Industrial Standards (JIS G 5121) (3% by weight or less). The amount of Mo added to the stainless cast steel may be more than 3% by weight and 3.5% by weight or less.

### Nb: Niobium

Nb affects high-temperature strength and thermal fatigue life of the stainless cast steel. Nb may also affect oxidation resistance, machinability, castability, and the like of the stainless cast steel. The amount of Nb in the stainless cast steel may be more than 1.0% by weight and 3.0% by weight or less.

### Cu: Copper

Cu affects high-temperature strength, ductility, toughness, and the like of the stainless cast steel. The amount of Cu in the stainless cast steel may be 3.5% by weight or less.

### C: Carbon

C affects high-temperature strength of the stainless cast steel. Also, C contributes to suppression of embrittlement and decrease in ductility of the stainless cast steel. The amount of C in the stainless cast steel may be more than 0.6% by weight and 1.1% by weight or less. A range of the amount of C added to the stainless cast steel may be larger in the entire range than a range of an amount of C added to stainless cast steel specified in Japanese Industrial Standards (JIS G 5121) (0.24% by weight or less).

### N: Nitrogen

N affects high-temperature strength, ductility, toughness, and the like of the stainless cast steel. N contributes to suppression of embrittlement of the stainless cast steel. The amount of N in the stainless cast steel may be more than 0.1% by weight and 0.7% by weight or less.

### Mn: Manganese, S: Sulfur

Mn and S affect a friction coefficient of the stainless cast steel. Mn and S crystallize as MnS in the stainless cast steel. The crystallized MnS reduces the friction coefficient. As a result, Mn and S contribute to improvement of the wear resistance of the stainless cast steel. The amount of Mn in the stainless cast steel may be more than 1.0% by weight and 2.0% by weight or less. The amount of S in the stainless cast steel may be more than 0.4% by weight and 0.7% by weight or less. A range of the amount of S added to the stainless cast steel may be larger in the entire range than a range of an amount of S added to stainless cast steel specified in Japanese Industrial Standards (JIS G 5121) (0.04% by weight or less). The range of the amount of S added to the stainless cast steel may be more than 0.5% by weight and 0.7% by weight or less.

### Si: Silicon

Si has a role as a deoxidizer during casting. Si contributes to improvement of oxidation resistance. Si affects stability of the austenite structure. The amount of Si in the stainless cast steel may be more than 2.5% by weight and 4.0% by weight or less. A range of the amount of Si added to the stainless cast steel may be larger in the entire range than a range of an amount of Si added to stainless cast steel specified in Japanese Industrial Standards (JIS G 5121) (2.0% by weight or less). The range of the amount of Si added to the stainless cast steel may be more than 3.5% by weight and 4.0% by weight or less.

### Fe

Fe constitutes a main component of the stainless cast steel. A content of Fe in the stainless cast steel may be the balance obtained by subtracting a total amount of the respective components from a total weight of the stainless cast steel.

Method for determining a composition of stainless cast steel focusing on wear resistance

It has already been described that crystallized MnS contributes to improvement of the wear resistance of the stainless cast steel. The crystallized MnS can be a starting point of pitting corrosion of the stainless cast steel. Therefore, an amount of MnS to be crystallized may be a minimum amount capable of realizing desired wear resistance. However, it has not been clarified what factors affect the amount of MnS to be crystallized. For example, although a qualitative fact that the amount of MnS to be crystallized increases as the amount of S increases is clear, there was no method for quantitatively predicting the amount of MnS to be crystallized.

Existence of factors affecting the wear resistance of the stainless cast steel other than the crystallized MnS was predicted. It is intended to quantitatively set the wear resistance of the stainless cast steel and determine a composition of the stainless cast steel that realizes a set target value. In this case, even if a qualitative target such as “since it is necessary to increase the amount of MnS to be crystallized in order to improve the wear resistance, the amount of S is increased” could be set, the amount of S could not be quantitatively set. In the first place, regarding determination of the composition of the stainless cast steel capable of realizing target wear resistance, it was also unclear whether it could be realized only by setting the amounts of Mn and S.

Therefore, as a result of the inventors of the present application conducting several evaluations described later and intensive studies, it was clarified that the wear resistance of the stainless cast steel can be quantitatively determined by adding the amount of Si to the evaluation in addition to the amounts of Mn and S. According to the method for determining a composition of stainless cast steel focusing on wear resistance found by the inventors, the wear amount can be predicted from the amounts of Mn, S, and Si. Therefore, if an allowable target wear amount is determined, the amounts of Mn, S, and Si that result in the target wear amount can be obtained by simple calculation.

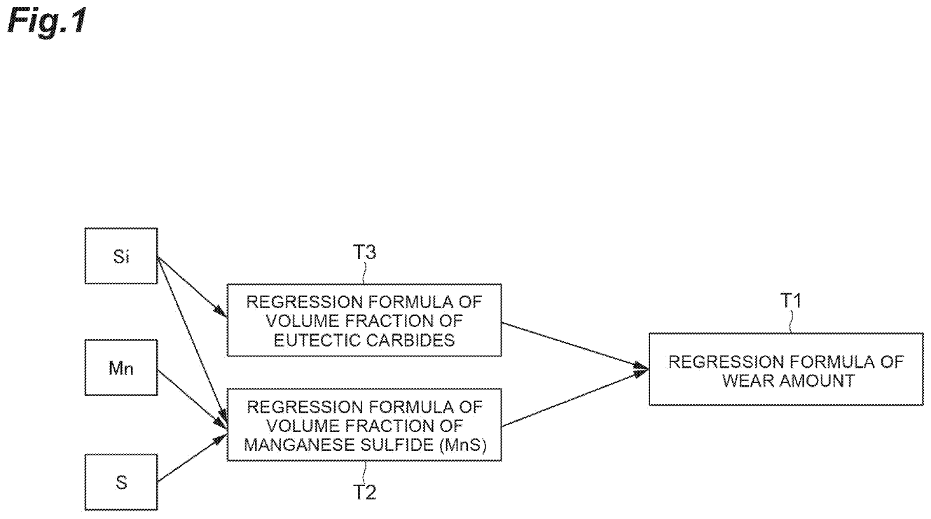

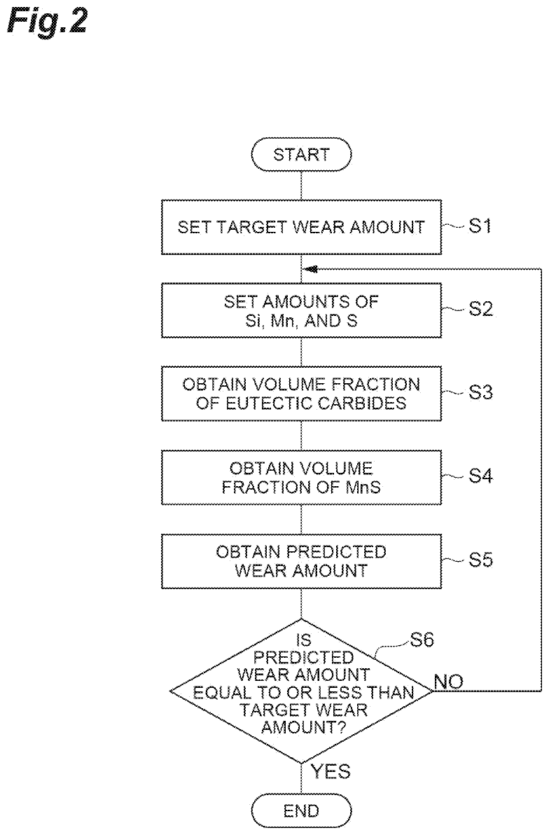

As shown in FIG. 1, in the method for determining a composition of stainless cast steel, first, a predicted wear amount is treated as a function having a volume fraction of MnS to be crystallized and a volume fraction of eutectic carbides as variables (T1 of FIG. 1). Furthermore, the volume fraction of MnS to be crystallized is treated as a function having the amounts of Mn, S, and Si as variables (T2 of FIG. 1), and the volume fraction of eutectic carbides is treated as a function having the amount of Si as a variable (T3 of FIG. 1). For example, the method for determining a composition of stainless cast steel can determine the amounts of Si, Mn, and S satisfying the target wear amount according to a flowchart shown in FIG. 2.

First, a target wear amount is set (S1 of FIG. 2). For example, this target wear amount may be defined as a sum of a wear amount of a base material made of the stainless cast steel and a wear amount of a counterpart material rubbing against the base material.

Next, amounts of Si, Mn, and S are set (S2 of FIG. 2).

Next, a volume fraction of eutectic carbides is obtained (S3 of FIG. 2). The volume fraction of eutectic carbides can be treated as a function having the amount of Si as a variable as shown in Formula (1). The function may be, for example, a quadratic function.

$${f}_{Carbide} = f ( [ Si ] ) \qquad ( 1 )$$

f_{Carbide}: Volume fraction of eutectic carbides (volume %).
[Si]: Amount of Si (% by weight).

Next, a volume fraction of MnS to be crystallized is obtained (S4 of FIG. 2). The volume fraction of MnS to be crystallized can be treated as a function having the amounts of Mn, S, and Si as variables as shown in Formula (2).

$${f}_{M n S} = f ( [ Mn ] , [ S ] , [ Si ] ) \qquad ( 2 )$$

f_{MnS}: Volume fraction of MnS.
[Mn]: Amount of Mn (% by weight).
[S]: Amount of S (% by weight).
[Si]: Amount of Si (% by weight).

Next, a predicted wear amount is obtained (S5 of FIG. 2). A predicted value of the wear amount can be treated as a function having the volume fraction of eutectic carbides and the volume fraction of MnS to be crystallized as variables as shown in Formula (3).

$${Wear}_{total} = f ( {f}_{Carbide} , {f}_{M n S} ) \qquad ( 3 )$$

Wearₜₒₜₐₗ: Predicted value of wear amount.
f_{Carbide}: Volume fraction of eutectic carbides (volume %).
f_{MnS}: Volume fraction of MnS (volume %).

Then, it is determined whether or not the predicted wear amount is equal to or less than the target wear amount (S6 of FIG. 2). When the predicted wear amount is equal to or less than the target wear amount (YES in S6 of FIG. 2), the amounts of Si, Mn, and S set in step S2 of FIG. 2 are adopted. When the predicted wear amount is not equal to or less than the target wear amount (NO in S6 of FIG. 2), the process returns to step S2 of FIG. 2 again, and the amounts of Si, Mn, and S are set again.

By repeating the above steps S1 to S6 of FIG. 2, the amounts of Si, Mn, and S satisfying the target wear amount can be determined.

Reference document 1 mentioned above qualitatively describes an effect of improving wear resistance by addition of MnS regarding a heat-resistant bearing material made of an austenitic iron casting alloy. However, a quantitative study on the effect of improving wear resistance has not been conducted, and a study on an optimal amount of crystallized MnS, that is, optimal amounts of Mn and S was insufficient. Further, in the bearing material described in Reference document 1, an influence of Si on the wear resistance has not been sufficiently studied, and a study on an optimal amount of Si was also insufficient.

For this reason, in the bearing material disclosed in Reference document 1, it was unclear whether the amount of each element constituting the bearing material was an optimal amount (chemical composition range) from a viewpoint of wear resistance. Therefore, an optimal chemical composition range and further improvement of wear resistance are studied.

The austenitic stainless cast steel may include 21 to 28% by weight of Cr; 14 to 23% by weight of Ni; 2.0 to 3.5% by weight of W; 1.0to 3.0% by weight of Nb; 1.5 to 3.5% by weight of Mo; 0 to 3.5% by weight of Cu; 0.6 to 1.1% by weight of C; 0.1 to 0.7% by weight of N; 1.0to 2.0% by weight of Mn; 0.4 to 0.7% by weight of S; 2.5 to 4.0% by weight of Si; and Fe as the balance.

According to this austenitic stainless cast steel, good wear resistance can be obtained by crystallized MnS and eutectic carbides caused by Si.

In some examples, Si may be more than 3.5% by weight and 4.0% by weight or less. In some examples, S may be more than 0.5% by weight and 0.7% by weight or less. Also with this composition, good wear resistance can be obtained.

The method of determining a composition of austenitic stainless cast steel may include: a step (S3) of obtaining a volume fraction of eutectic carbides using an amount of Si; a step (S4) of obtaining a volume fraction of MnS to be crystallized using amounts of Mn and S; and a step (S5) of obtaining a predicted wear amount using the volume fraction of eutectic carbides and the volume fraction of MnS.

According to this method, a wear amount of a member constituted by austenitic stainless cast steel can be predicted from the amounts of Si, Mn, and S. Therefore, by repeating setting of the amounts of Si, Mn, and S and prediction of the wear amount derived from the amounts, the amounts of Si, Mn, and S satisfying a desired target wear amount can be obtained.

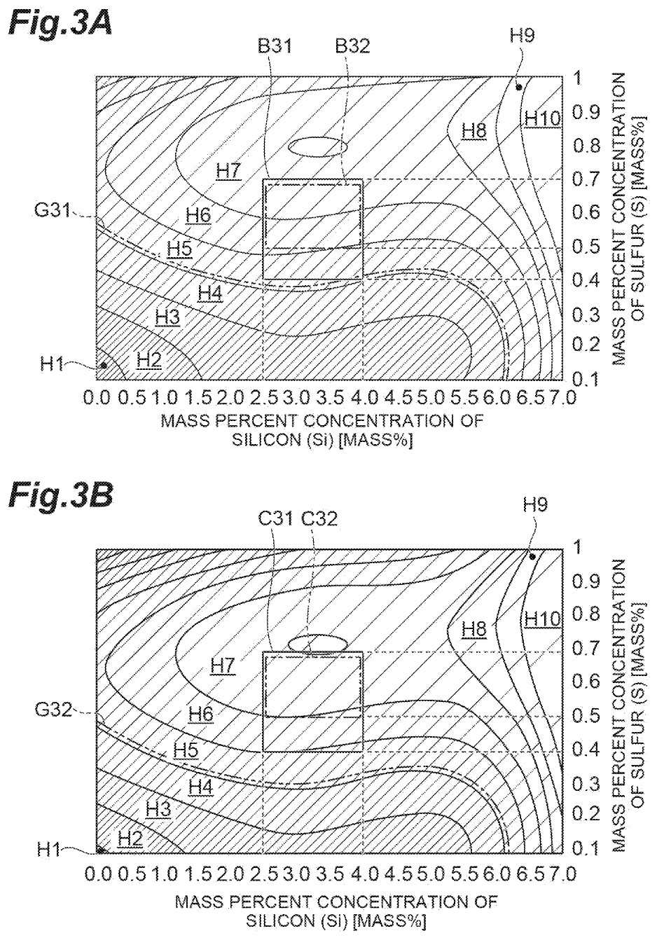

Here, according to the above Formulas (1), (2), and (3), contour diagrams shown in FIG. 3A and FIG. 3B can be drawn. The horizontal axis represents % by weight of Si. The vertical axis represents % by weight of S. FIG. 3A is a contour diagram when the amount of Mn is 1.0% by weight. FIG. 3B is a contour diagram when the amount of Mn is 2.0% by weight. In each figure, as a comparative example, a wear amount (58.5 μm) in the material described in Reference document 1 is also shown (G31, G32). Relationships between regions H1 to H10 drawn separately by hatching in FIG. 3A and FIG. 3B and the wear amount are as follows.

H1: Region where predicted wear amount is 90 to 100 micrometers.

H2: Region where predicted wear amount is 80 to 90 micrometers.

H3: Region where predicted wear amount is 70 to 80 micrometers.

H4: Region where predicted wear amount is 60 to 70 micrometers.

H5: Region where predicted wear amount is 50 to 60 micrometers.

H6: Region where predicted wear amount is 40 to 50 micrometers.

H7: Region where predicted wear amount is 30 to 40 micrometers.

H8: Region where predicted wear amount is 20 to 30 micrometers.

H9: Region where predicted wear amount is 10 to 20 micrometers.

H10: Region where predicted wear amount is 0 to 10 micrometers.

From FIG. 3A and FIG. 3B, it was found that in a range where the amount of S is 0.7% by weight or less and the amount of Si is 0 to 5.0% by weight, the predicted value of the sliding wear amount takes a minimum value when the amount of Si is around 3.0% by weight.

For example, it can be seen that when the amount of Si is more than 2.5% by weight and 4.0% by weight or less, the predicted wear amount shown in regions B31 and C31 is obtained by setting the amount of S to be more than 0.4% by weight and 0.7% by weight or less. It can also be read that by further limiting the range of the amount of S (more than 0.5% by weight and 0.7% by weight or less), the predicted wear amount can be further reduced as shown in regions B32 and C32.

The present disclosure will be described in further detail by the following Examples 1 to 7, Reference Examples 1 to 12, and Comparative Example 1, but the present disclosure is not limited to these examples.

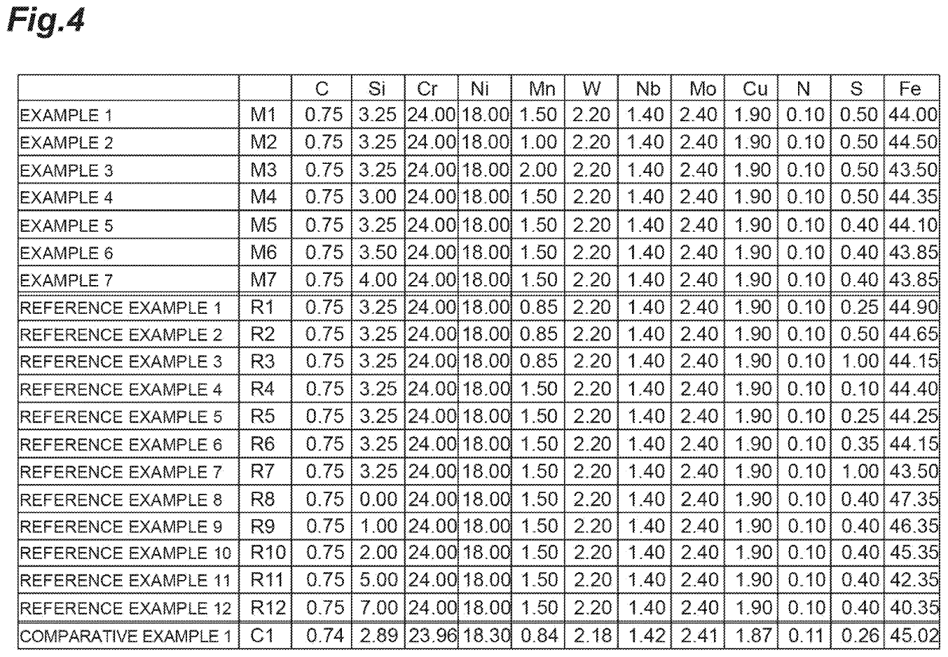

The table of FIG. 4 shows compositions of specimens of stainless cast steel which are Examples 1 to 7, Reference Examples 1 to 12, and Comparative Example 1. The stainless cast steels of Examples 1 to 7 are constituted by a composition included in numerical ranges shown below (this composition may be referred to as an “example composition”).
Cr: 21 to 28% by weight
Ni: 14 to 23% by weight
W: 2.0 to 3.5% by weight
Nb: 1.0 to 3.0% by weight
Mo: 1.5 to 3.5% by weight
Cu: 0 to 3.5% by weight
C: 0.6 to 1.1% by weight
N: 0.1 to 0.7% by weight
Mn: 1.0 to 2.0% by weight
S: 0.4 to 0.7% by weight
Si: 2.5 to 4.0% by weight
Fe: balance

The stainless cast steel of Comparative Example 1 is constituted by a composition in which amounts of Mn, S, and Si are exemplified in Reference document 1 described above.

### Evaluation 1: Amount of S and Volume Fraction of Crystallized MnS

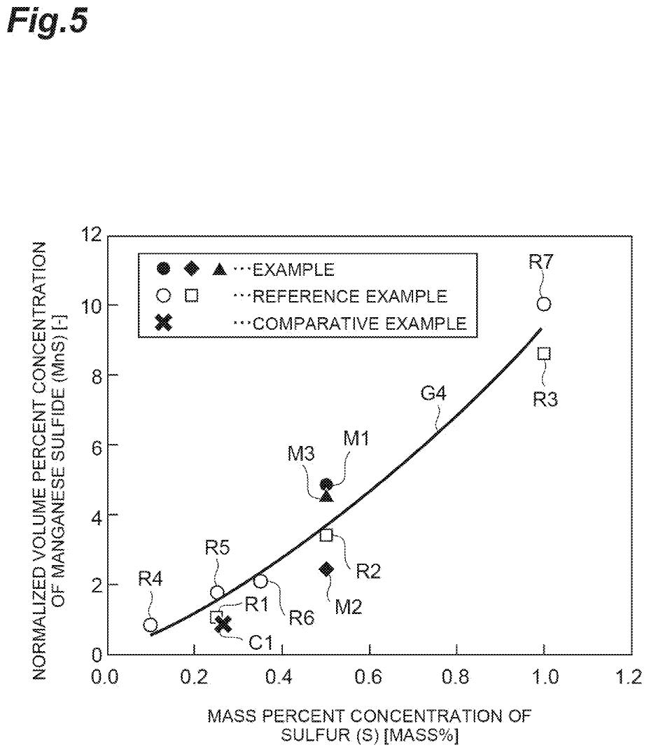

FIG. 5 is a graph showing a relationship between the amount of S and the volume fraction of crystallized MnS. The horizontal axis represents mass percent concentration of S. The vertical axis represents normalized volume % of MnS. Here, the normalized volume % of MnS is obtained by normalizing values of Examples and Reference Examples with volume % of MnS of Comparative Example 1 (marker C1) as 1.

In this Evaluation 1, it was confirmed that the volume fraction of crystallized MnS is shown as a function of the amount of S under a condition where the amount of Si is a constant value (3.25 mass percent concentration).

A curve G4 is an approximate curve for all markers. It was found that the volume fraction of crystallized MnS increased as the amount of S increased. From this, it was found that the volume fraction of crystallized MnS had a correlation with the amount of S. Therefore, it was confirmed that under conditions where the amount of Si is 3.25% by weight and the amount of Mn is 0.85% by weight or more and 2.0% by weight or less, the volume fraction of crystallized MnS can be shown as a function of the amount of S.

### Evaluation 2: Amount of S and Volume Fraction of Crystallized Eutectic Carbides

Under the same conditions as Evaluation 1, a relationship between the amount of S and the volume fraction of crystallized eutectic carbides was confirmed by the same method as Evaluation 1. As a result, it was not recognized that the volume fraction of crystallized eutectic carbides changed significantly as the amount of S increased.

### Evaluation 3: Relationship Between Amount of Mn and Volume Fraction of Crystallized MnS

Under the same conditions as Evaluation 1, a relationship between the amount of Mn and the volume fraction of crystallized MnS was confirmed by the same method as Evaluation 1. As a result, it was not recognized that the volume fraction of crystallized MnS changed significantly as the amount of Mn increased.

### Evaluation 4: Relationship Between Amount of Mn and Volume Fraction of Crystallized Eutectic Carbides

Under the same conditions as Evaluation 1, a relationship between the amount of Mn and the volume fraction of crystallized eutectic carbides was confirmed by the same method as Evaluation 1. As a result, it was not recognized that the volume fraction of crystallized eutectic carbides changed significantly as the amount of Mn increased (see markers M1, M2, and M3 in FIG. 5).

### Evaluation 5: Relationship Between Amount of Si and Area Ratio of Crystallized MnS

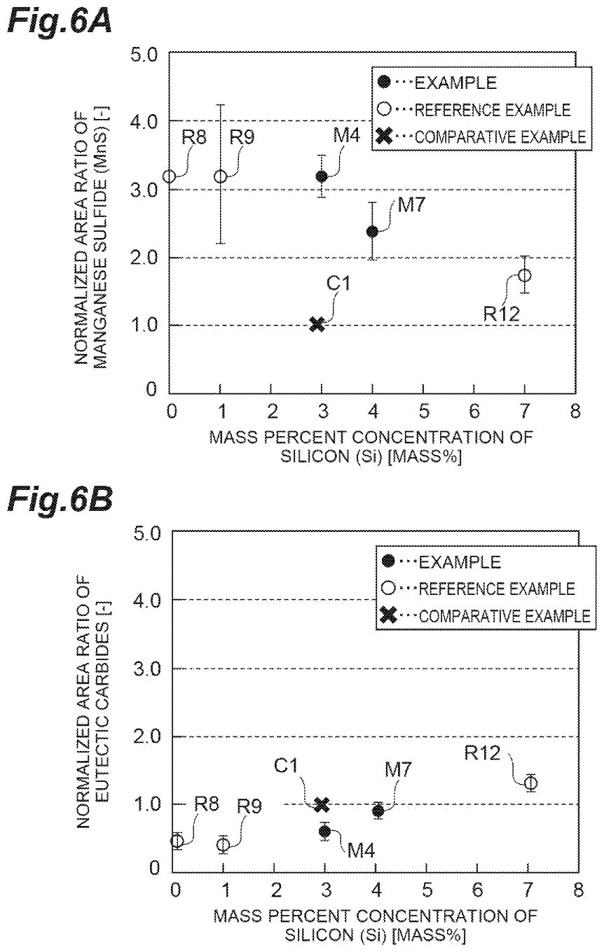

FIG. 6A shows a relationship between the amount of Si and the area ratio of crystallized MnS. The horizontal axis represents % by weight of Si. The vertical axis represents a normalized area ratio of MnS. Here, the normalized area ratio of MnS is obtained by normalizing values of Examples and Reference Examples with an area ratio of MnS of Comparative Example 1 (marker C1) as 1. From FIG. 6A, it was confirmed that the area ratio of crystallized MnS decreased as the amount of Si increased.

### Evaluation 6: Relationship between Amount of Si and Area Ratio of Crystallized Eutectic Carbides

FIG. 6B is a graph showing a relationship between the amount of Si and the area ratio of crystallized eutectic carbides. The horizontal axis represents % by weight of Si. The vertical axis represents a normalized area ratio of eutectic carbides. Here, the normalized area ratio of eutectic carbides is obtained by normalizing values of Examples and Reference Examples with an area ratio of eutectic carbides of Comparative Example 1 (marker C1) as 1. From FIG. 6B, it was confirmed that the area ratio of eutectic carbides increased as the amount of Si increased.

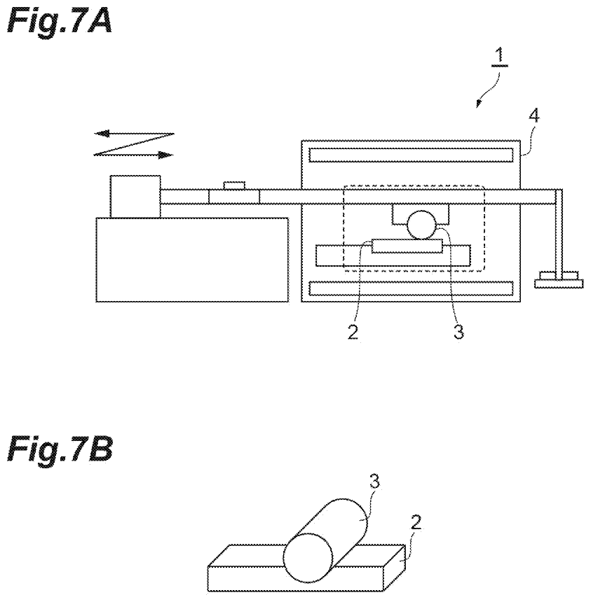

FIG. 7A and FIG. 7B are diagrams showing an outline of a test apparatus 1 used for the high-temperature wear test. For each of Examples and Reference Examples, a flat plate test piece 2 having a width of 35 mm, a depth of 12 mm, and a thickness of 6 mm was prepared. A cylindrical test piece 3 having a diameter of 12 mm and a height of 20 mm was prepared as a counterpart material of the flat plate test piece 2. A material of the cylindrical test piece 3 was Inconel 718.

The flat plate test piece 2 and the cylindrical test piece 3 were both placed in a furnace 4 heated to 300° C. or 900° C. In this furnace 4, the cylindrical test piece 3 was slid back and forth in a horizontal direction on the flat plate test piece 2 while being pressed against the flat plate test piece 2 in a vertical direction with a constant load. An example of conditions is as follows.
Load: 11 N
Number of reciprocations: 1000 times
Sliding speed: 3.6 mm/sec
Stroke width: 10 mm

### Evaluation 7: High-Temperature Wear Test/Relationship Between Volume Fraction of Crystallized MnS and Wear Amount

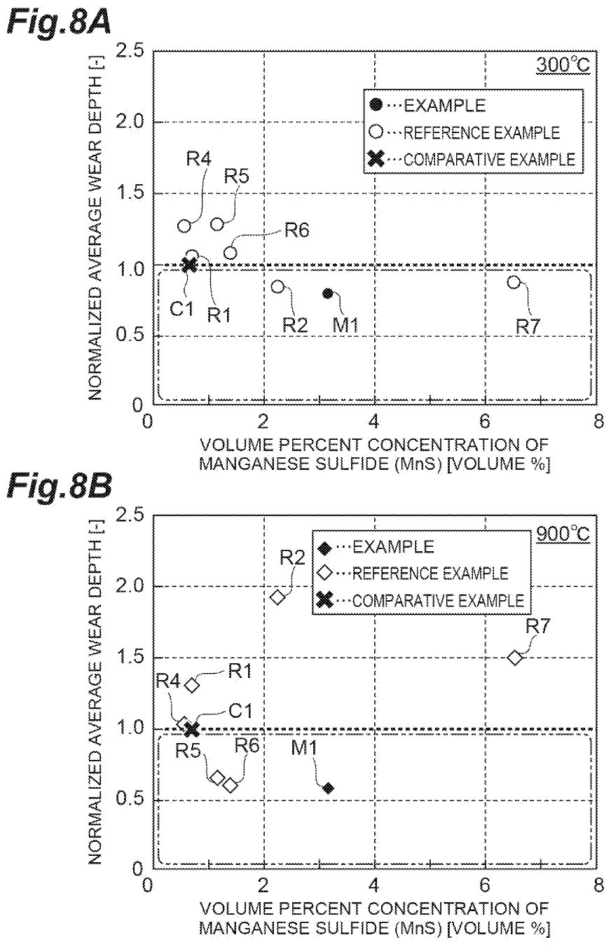

FIG. 8A and FIG. 8B are graphs showing a relationship between the volume fraction of crystallized MnS and the wear amount. FIG. 8A shows the volume fraction of MnS and the wear amount at 300° C. FIG. 8B shows the volume fraction of MnS and the wear amount at 900° C. The horizontal axis represents volume % of MnS. The vertical axis represents a normalized average wear depth. The average wear depth is a numerical value obtained by summing respective average wear depths of the flat plate test piece 2 and the cylindrical test piece 3. The normalized average wear depth is obtained by normalizing values of Examples and Reference Examples with an average wear depth of Comparative Example 1 (marker C1) as 1. In Evaluation 7, the amounts of Si were all 3.25% by weight.

According to FIG. 8A, it was confirmed that in Example 1 (marker M1) which is within the range of the example composition, the wear amount was smaller than in Comparative Example 1 (marker C1) which is outside the range of the example composition. That is, it was confirmed that the wear resistance of the stainless cast steel within the range of the example composition was improved. Also, it was found that the wear amount at 300° C. tended to decrease as the amount of MnS increased.

FIG. 8B is a graph showing a relationship between the volume fraction of crystallized MnS and the wear amount at 900° C. Also at 900° C., it was confirmed that in Example 1 (marker M1) which is within the range of the example composition, the wear amount was smaller than in Comparative Example 1 (marker C1) which is outside the range of the example composition. That is, it was confirmed that the wear resistance of the stainless cast steel within the range of the example composition was improved. On the other hand, unlike the case of 300° C., a contribution of the amount of MnS to the wear amount at 900° C. was not significant.

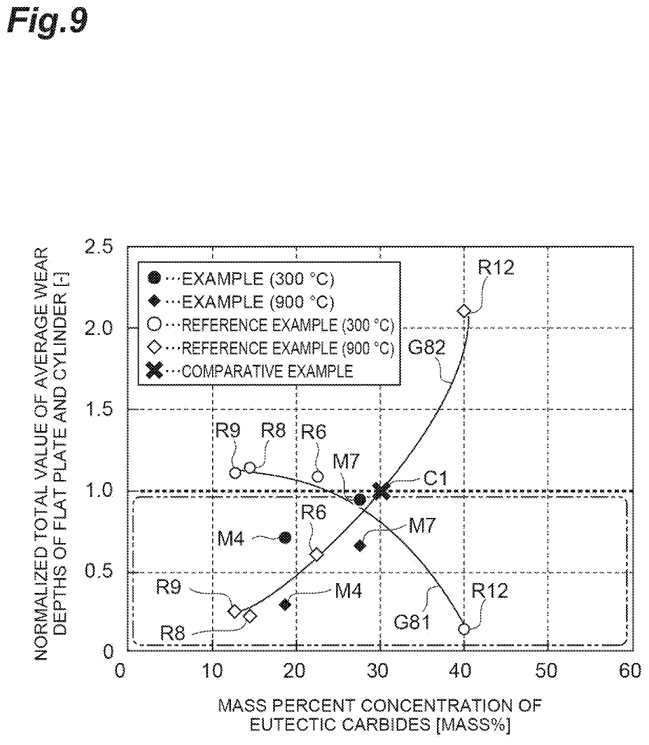

FIG. 9 is a graph showing a relationship between an amount of crystallized eutectic carbides and a wear amount at 300° C. or 900° C. All markers described in FIG. 9 are evaluation results of test pieces in which the amount of Mn is 1.5% by weight and the amount of S is 0.35 to 0.40% by weight. The horizontal axis represents % by weight of eutectic carbides. The vertical axis represents a normalized average wear depth. On the vertical axis, the average wear depth of each test piece at 300° C. was normalized so that the average wear depth of Comparative Example 1 at 300° C. (marker C1) became 1. The average wear depth of each test piece at 900° C. was normalized so that the average wear depth of Comparative Example 1 at 900° C. (marker C1) became 1.

It was found that the average wear depths of Examples 4 and 7 (markers M4 and M7) at 300° C. were both smaller than that of Comparative Example 1 (marker C 1). It was found that the average wear depths of Examples 4 and 7 (markers M4 and M7) at 900° C. were both smaller than that of Comparative Example 1 (marker C1). Therefore, it was confirmed that at either 300° C. or 900° C., Examples 4 and 7 were superior in wear resistance compared to Comparative Example 1.

As shown in a graph G81, in the case of 300° C., a tendency that the average wear depth decreased as the eutectic carbides increased was observed. In the case of 300° C., it was confirmed that the eutectic carbides contributed to improvement of the wear resistance. As shown in a graph G82, in the case of 900° C., a tendency that the average wear depth increased as the eutectic carbides increased was observed. In the case of 900° C., it was confirmed that there is a possibility that the eutectic carbides do not contribute to improvement of the wear resistance. Therefore, it was found that there was a correlation between the volume fraction of crystallized eutectic carbides and the wear amount. Since the contribution of eutectic carbides to wear resistance differs depending on the temperature, it is considered that the volume fraction of eutectic carbides is preferably about 20 to 30 volume %.

### Evaluation 8: High-Temperature Wear Test/Relationship between Amount of Si and Wear Amount of Flat Plate Test Piece 2 (Part 1)

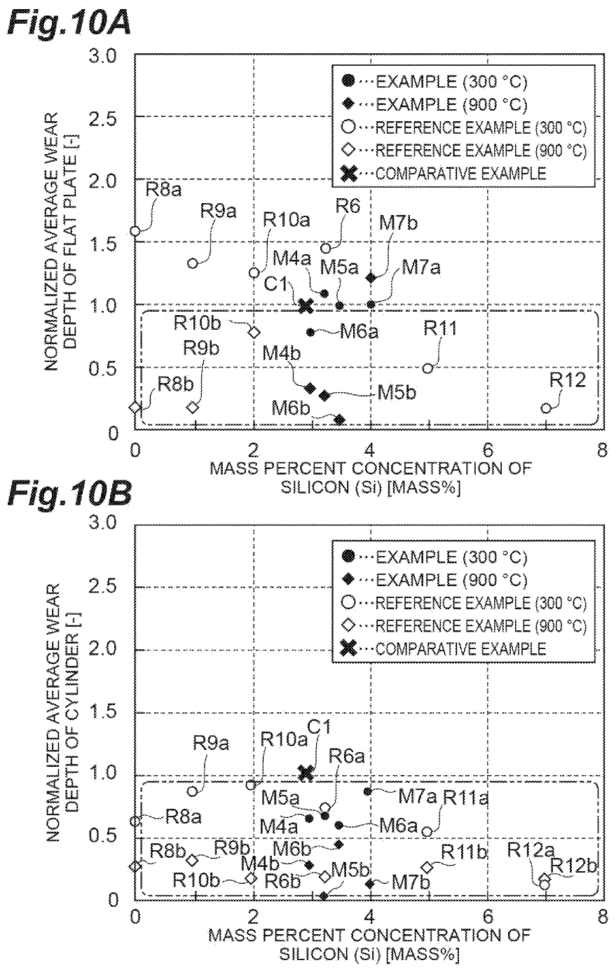

In Evaluation 8, a relationship between the amount of Si and the wear amount of the flat plate test piece 2, and a relationship between the amount of Si and the wear amount of the cylindrical test piece 3 were confirmed. FIG. 10A shows the relationship between the amount of Si and the wear amount of the flat plate test piece 2. FIG. 10B shows the relationship between the amount of Si and the wear amount of the cylindrical test piece 3. In Evaluation 8, the amount of Mn was 1.5% by weight, and the amount of S was 0.35 to 0.40% by weight. The horizontal axis represents % by weight of Si. The vertical axis represents a normalized average wear depth of the flat plate test piece 2. The average wear depth of each test piece at 300° C. is obtained by normalizing values of Examples and Reference Examples with the average wear depth of Comparative Example 1 at 300° C. (marker C1) as 1. In each figure, round markers show results at 300° C. Diamond-shaped markers show results at 900° C.

Since FIG. 10A is a result of the flat plate test piece 2 formed of the stainless cast steel, it means ease of wear of the stainless cast steel itself. According to FIG. 10A, it was found that the average wear depths of respective Examples 4 to 7 of the flat plate test piece 2 at 300° C. were all smaller than that of Comparative Example 1 (marker C1). It was found that the average wear depths of respective Examples 4 to 7 at 300° C. were all smaller than that of Comparative Example 1 (marker C1). It was found that at 300° C., the average wear depth of the flat plate test piece 2 decreased as the Si amount increased. It was found that at 900° C., the average wear depth of the flat plate test piece 2 increased as the amount of Si increased.

Since FIG. 10B is a result of the cylindrical test piece 3 formed of another material that is not the stainless cast steel, it means ease of causing wear to the counterpart material by the stainless cast steel. According to FIG. 10B, it was found that the average wear depths of the cylindrical test piece 3 (counterpart material) at 300° C. were all smaller than that of Comparative Example 1 (marker C1). It was found that the average wear depths of respective Examples 4 to 7 at 900° C. were all smaller than that of Comparative Example 1 (marker C1). It was found that at 300° C., the average wear depth of the cylindrical test piece 3 decreased as the amount of Si increased. It was found that at 900° C., the average wear depth of the cylindrical test piece 3 hardly changed as the amount of Si increased.

In Evaluation 8, the following could be confirmed.

At 300° C., wear amounts of both the flat plate test piece 2 (austenitic cast steel) and the cylindrical test piece 3 (counterpart material) decrease as the amount of Si increases.

At 900° C., the wear amount of the flat plate test piece 2 (austenitic cast steel) tends to increase, but the wear amount of the cylindrical test piece 3 (counterpart material) decreases.

### Evaluation 9: High-Temperature Wear Test/Relationship between Amount of Si and Wear Amount of Flat Plate Test Piece 2 (Part 2)

In Evaluation 8, the wear amount was evaluated for each of the flat plate test piece 2 and the cylindrical test piece 3. In Evaluation 9, the wear amounts of the flat plate test piece 2 and the cylindrical test piece 3 were comprehensively evaluated.

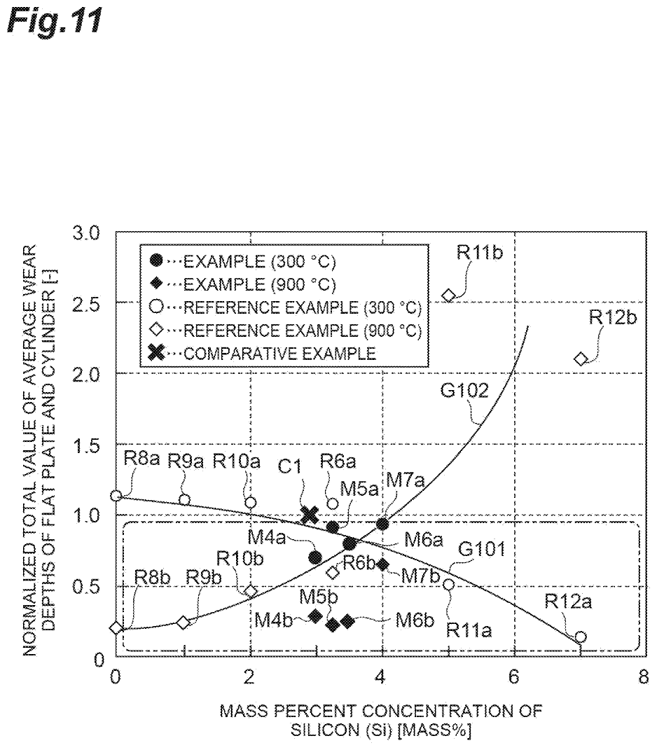

FIG. 11 shows a relationship between the amount of Si and a total value of wear amounts of the flat plate test piece 2 and the cylindrical test piece 3. The horizontal axis is % by weight of silicon. The vertical axis is a normalized total value of average wear depths of the flat plate test piece 2 and the cylindrical test piece 3 (total average wear depth). Examples and Reference Examples are normalized with a total average wear depth (marker C1) of Comparative Example 1 at each temperature (300° C. or 900° C.) as 1.

From FIG. 11, it was found that in the case of 300° C., total average wear depths of respective Examples 4 to 7 (markers M4a to 7a) were smaller than the total average wear depth of Comparative Example 1 (marker C1 a). It was found that in the case of 900° C. as well, total average wear depths of respective Examples 4 to 7 (markers M4b to M7b) were smaller than the total average wear depth of Comparative Example 1 (marker C1 b). Therefore, it was found that in both cases of 300° C. or 900° C., the total average wear depths of respective Examples 4 to 7 were smaller than the average wear depth of Comparative Example 1.

It was found that the total average wear depths of respective Examples 4 to 7 at 300° C. decreased as the amount of Si increased (see graph G101). It was found that the total average wear depths of respective Examples 4 to 7 at 900° C. increased as the amount of Si increased (see graph G102).

As described above, according to Evaluations 1 to 10, it was confirmed that the austenitic cast steel within the range of the example composition can improve wear resistance compared to that of the comparative example.

Furthermore, the austenitic cast steel within the range of the example composition was evaluated from a viewpoint different from wear resistance.

### Evaluation 11: Corrosion Resistance Test

As described above, it is known that MnS contributes to improvement of wear resistance but can be a starting point of pitting corrosion. Therefore, corrosion resistance was evaluated for the austenitic cast steel within the range of the example composition.

In the corrosion resistance test, an anodic polarization test was performed after performing corrosion potential measurement. In the corrosion potential measurement, first, a test piece was immersed in a 5 wt % (weight percent) NaCl aqueous solution, and a corrosion potential of each test piece was measured for 48 hours. The corrosion potential measurement was performed at a temperature of 60° C. in a state open to the atmosphere. Subsequently, the anodic polarization test was performed using the same test piece. The anodic polarization test was performed with a potential sweep rate of 20 mV/min.

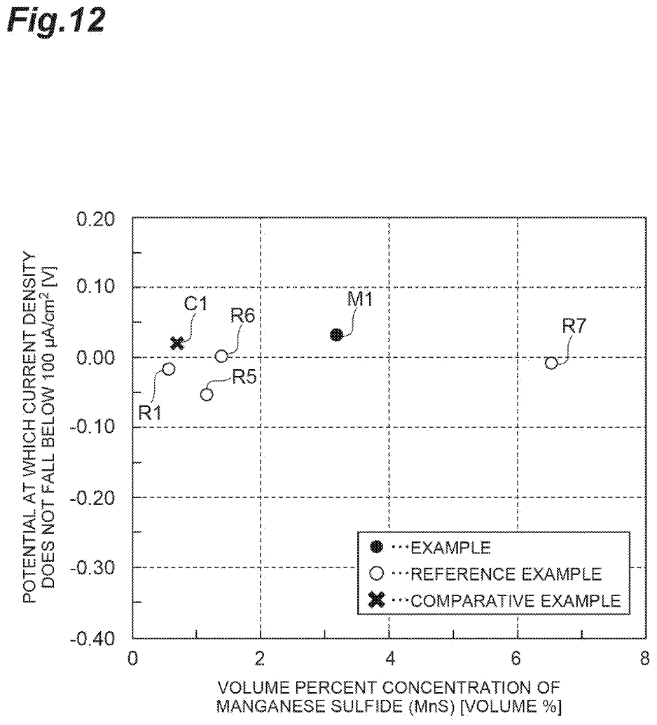

FIG. 12 shows test results of the corrosion resistance test. The horizontal axis represents volume % of MnS. The vertical axis represents a potential (V) at which a current density does not fall below 100 μA/cm²in the anodic polarization test. The vertical axis shows a potential at which the current density exceeds 100 μA/cm² and does not fall below it when the potential is gradually increased in the anodic polarization test, and it means that the larger this potential is, the better the corrosion resistance is.

It was found that a potential indicated by the marker M1 of Example 1 was substantially equivalent to potentials indicated by markers R4 to R7 of Reference Examples 4 to 7 and the marker C1 of Comparative Example 1. Thus, it was confirmed that the corrosion resistance of the test piece of Example 1 was not significantly different from the corrosion resistance of the test piece of Comparative Example 1. Generally, it is known that MnS in stainless steel becomes a starting point of pitting corrosion, but a clear correlation was not recognized between the amount of crystallized MnS and the corrosion resistance. Therefore, it was confirmed that at least in a range where the volume % of MnS is 0.5 to 6.5%, a significant decrease in corrosion resistance does not occur.

### Evaluation 12: Relationship Between Amount of Si and Vickers Hardness

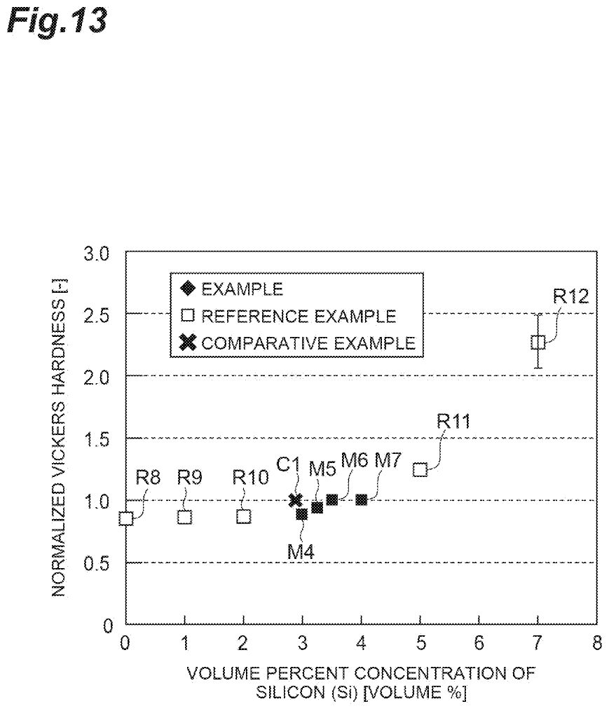

In Evaluation 12, a relationship between the amount of Si and Vickers hardness was evaluated. FIG. 13 is a graph showing the relationship between the amount of Si and Vickers hardness. The horizontal axis represents % by weight of Si. The vertical axis represents normalized Vickers hardness. Here, the normalized Vickers hardness on the vertical axis is obtained by normalizing Examples and Reference Examples with the Vickers hardness of Comparative Example 1 (marker C1) as 1.

From FIG. 13, almost no change was recognized in the Vickers hardness in a range where the amount of Si was 0 to 3.0% by weight. When the amount of Si exceeded 3.0% by weight, the Vickers hardness increased. When the amount of Si was 7.0% by weight, a significant increase in the Vickers hardness was recognized. It is considered that the increase in the Vickers hardness accompanying the increase in the amount of Si is caused by an increase in eutectic carbides accompanying the increase in the amount of Si. From the above, it was found that when the amount of Si is 2.5 to 4.0% by weight, a decrease in the Vickers hardness accompanying the increase in the amount of Si was not recognized.

It is to be understood that not all aspects, advantages and features described herein may necessarily be achieved by, or included in, any one particular example. Indeed, having described and illustrated various examples herein, it should be apparent that other examples may be modified in arrangement and detail.

The examples of the austenitic stainless cast steel and the method of determining a composition of austenitic stainless cast steel have been described above. The austenitic stainless cast steel and the method of determining a composition of austenitic stainless cast steel are not limited to the above examples and may be implemented in various forms.

The austenitic stainless cast steel may be used, for example, as a material for a part of a wastegate valve incorporated in a turbocharger.

A wastegate valve of a vehicle turbocharger adjusts a flow rate of exhaust gas supplied to a turbine by diverting a part of exhaust gas flowing through the turbocharger. Therefore, the wastegate valve is exposed to exhaust gas. The exhaust gas may include corrosive components. When the wastegate valve is exposed to exhaust gas for a long time, corrosion may occur in parts constituting the wastegate valve due to the corrosive components. Corrosion occurring in the parts can be a cause of impairing a function of the wastegate valve. For example, if a clearance between a shaft supporting the valve and a bearing disappears due to corrosion, sticking between the shaft and the bearing may occur.

The austenitic stainless cast steel can be used as a material for a bearing that rotatably supports a valve. According to a wastegate valve provided with a part using the austenitic stainless cast steel, wear resistance against friction occurring in a bearing accompanying valve opening and closing during turbo operation can be improved.

The austenitic stainless cast steel may include other components (such as impurities) in addition to Cr, Ni, W, Nb, Mo, Cu, C, N, Mn, S, Si, and Fe.

An example austenitic stainless cast steel, based on a total amount of the austenitic stainless cast steel, may include: 21 to 28% by weight of Cr; 14 to 23% by weight of Ni; 2.0 to 3.5% by weight of W; 1.0to 3.0% by weight of Nb; 1.5 to 3.5% by weight of Mo; 0 to 3.5% by weight of Cu; 0.6 to 1.1% by weight of C; 0.1 to 0.7% by weight of N; 1.0to 2.0% by weight of Mn; 0.4 to 0.7% by weight of S; 2.5 to 4.0% by weight of Si; and Fe as the balance.

According to this austenitic stainless cast steel, good wear resistance can be obtained by crystallized MnS and eutectic carbides caused by Si.

In some examples, Si may be more than 3.5% by weight and 4.0% by weight or less based on a total amount of the austenitic stainless cast steel. Also with this composition, good wear resistance can be obtained.

In some examples, S may be more than 0.5% by weight and 0.7% by weight or less based on a total amount of the austenitic stainless cast steel. Also with this composition, good wear resistance can be obtained.

An example method of determining a composition of austenitic stainless cast steel may include: obtaining a volume fraction of eutectic carbides using an amount of Si; obtaining a volume fraction of MnS to be crystallized using amounts of Mn and S: and obtaining a predicted wear amount using the volume fraction of eutectic carbides and the volume fraction of MnS.

According to this method, a wear amount of a member constituted by austenitic stainless cast steel can be predicted from the amounts of Si, Mn, and S. Therefore, by repeating setting of the amounts of Si, Mn, and S and prediction of the wear amount derived from the amounts, the amounts of Si, Mn, and S satisfying a target wear amount can be obtained.

An example austenitic stainless cast steel may include, based on a total amount of the austenitic stainless cast steel: 21 to 28% by weight of Cr; 14 to 23% by weight of Ni; 2.0 to 3.5% by weight of W; 1.0 to 3.0% by weight of Nb; 1.5 to 3.5% by weight of Mo; 0 to 3.5% by weight of Cu; 0.6 to 1.1% by weight of C; 0.1 to 0.7% by weight of N; 1.0 to 2.0% by weight of Mn; 0.4 to 0.7% by weight of S; 2.5 to 4.0% by weight of Si; and Fe.

In some examples, the Si may be more than 3.5% by weight based on the total amount of the austenitic stainless cast steel.

In some examples, the S may be more than 0.5% by weight based on the total amount of the austenitic stainless cast steel.

In some examples, the Cr may be more than 27% by weight based on the total amount of the austenitic stainless cast steel.

In some examples, the Ni may be more than 22% by weight based on the total amount of the austenitic stainless cast steel.

In some examples, the Mo may be more than 3.0% by weight based on the total amount of the austenitic stainless cast steel.

An example method of determining a composition of austenitic stainless cast steel may include: obtaining a volume fraction of eutectic carbides based on an amount of Si; obtaining a volume fraction of MnS to be crystallized based on amounts of Mn and S; and obtaining a predicted wear amount based on the volume fraction of eutectic carbides and the volume fraction of MnS.

In some examples, obtaining the volume fraction of MnS may include obtaining the volume fraction of MnS to be crystallized based on the amounts of Si, Mn and S.

An example austenitic stainless cast steel may consist of, based on a total amount of the austenitic stainless cast steel: 21 to 28% by weight of Cr; 14 to 23% by weight of Ni; 2.0 to 3.5% by weight of W; 1.0 to 3.0% by weight of Nb; 1.5 to 3.5% by weight of Mo; 0 to 3.5% by weight of Cu; 0.6 to 1.1% by weight of C; 0.1 to 0.7% by weight of N; 1.0 to 2.0% by weight of Mn; 0.4 to 0.7% by weight of S; 2.5 to 4.0% by weight of Si; and Fe.

In some examples, the Si may be more than 3.5% by weight based on the total amount of the austenitic stainless cast steel.

In some examples, the S may be more than 0.5% by weight based on the total amount of the austenitic stainless cast steel.

In some examples, the Cr may be more than 27% by weight based on the total amount of the austenitic stainless cast steel.

In some examples, the Ni may be more than 22% by weight based on the total amount of the austenitic stainless cast steel.

In some examples, the Mo may be more than 3.0% by weight based on the total amount of the austenitic stainless cast steel.

What is claimed is:

1. Austenitic stainless cast steel comprising, based on a total amount of the austenitic stainless cast steel:
21 to 28% by weight of Cr;
14 to 23% by weight of Ni;
2.0 to 3.5% by weight of W;
1.0 to 3.0% by weight of Nb;
1.5 to 3.5% by weight of Mo;
0 to 3.5% by weight of Cu;
0.6 to 1.1% by weight of C;
0.1 to 0.7% by weight of N;
1.0 to 2.0% by weight of Mn;
0.4 to 0.7% by weight of S;
2.5 to 4.0% by weight of Si; and
Fe.

2. The austenitic stainless cast steel according to claim 1, wherein the Si is more than 3.5% by weight based on the total amount of the austenitic stainless cast steel.

3. The austenitic stainless cast steel according to claim 1, wherein the S is more than 0.5% by weight based on the total amount of the austenitic stainless cast steel.

4. The austenitic stainless cast steel according to claim 1, wherein the Cr is more than 27% by weight based on the total amount of the austenitic stainless cast steel.

5. The austenitic stainless cast steel according to claim 1, wherein the Ni is more than 22% by weight based on the total amount of the austenitic stainless cast steel.

6. The austenitic stainless cast steel according to claim 1, wherein the Mo is more than 3.0% by weight based on the total amount of the austenitic stainless cast steel.

7. A method of determining a composition of austenitic stainless cast steel, the method comprising:
obtaining a volume fraction of eutectic carbides based on an amount of Si;
obtaining a volume fraction of MnS to be crystallized based on amounts of Mn and S; and
obtaining a predicted wear amount based on the volume fraction of eutectic carbides and the volume fraction of MnS.

8. The method according to claim 7, wherein obtaining the volume fraction of MnS includes obtaining the volume fraction of MnS to be crystallized based on the amounts of Si, Mn and S.

9. Austenitic stainless cast steel consisting of, based on a total amount of the austenitic stainless cast steel:
21 to 28% by weight of Cr;
14 to 23% by weight of Ni;
2.0 to 3.5% by weight of W;
1.0 to 3.0% by weight of Nb;
1.5 to 3.5% by weight of Mo;
0 to 3.5% by weight of Cu;
0.6 to 1.1% by weight of C;
0.1 to 0.7% by weight of N;
1.0 to 2.0% by weight of Mn;
0.4 to 0.7% by weight of S;
2.5 to 4.0% by weight of Si; and
Fe.

10. The austenitic stainless cast steel according to claim 9, wherein the Si is more than 3.5% by weight based on the total amount of the austenitic stainless cast steel.

11. The austenitic stainless cast steel according to claim 9, wherein the S is more than 0.5% by weight based on the total amount of the austenitic stainless cast steel.

12. The austenitic stainless cast steel according to claim 9, wherein the Cr is more than 27% by weight based on the total amount of the austenitic stainless cast steel.

13. The austenitic stainless cast steel according to claim 9, wherein the Ni is more than 22% by weight based on the total amount of the austenitic stainless cast steel.

14. The austenitic stainless cast steel according to claim 9, wherein the Mo is more than 3.0% by weight based on the total amount of the austenitic stainless cast steel.
